(19) United States
(12) Patent Application Publication
(10) Pub. No.: US 2014/0225997 A1
(43) Pub. Date: Aug. 14, 2014

(54) LOW VISION DEVICE AND METHOD FOR RECORDING AND DISPLAYING AN OBJECT ON A SCREEN

(71) Applicant: OPTELEC DEVELOPMENT B.V., Barendrecht (NL)

(72) Inventor: Robert AUGER, Barendrecht (CA)

(73) Assignee: OPTELEC DEVELOPMENT B.V., Barendrecht (NL)

(21) Appl. No.: 14/180,940

(22) Filed: Feb. 14, 2014

(30) Foreign Application Priority Data
Feb. 14, 2013 (NL) 2010300
Feb. 25, 2013 (NL) 2010357

(51) Int. Cl. H04N 5/232; G06F 3/0484; G06F 3/0488; G06T 3/40; G06K 9/62

(52) U.S. Cl. CPC H04N 5/23229; G06T 3/40; G06K 9/62; G06F 3/0488; G06F 3/04842
USPC 348/63; 348/62

(57) ABSTRACT

Low vision device for recording an object whereon text and/or at least one picture are visible and for displaying the recorded object on a screen, provided with a light sensitive sensor for recording the object and providing recording signals representing the recorded object, processing means for processing the recording signals into video signals and a screen which, in use, is provided with the video signals for displaying an image of the recorded object on the screen, wherein the processing means is arranged for recognizing, based on the recording signals connected parts of text and/or at least one picture on the object, wherein the screen is arranged as a touch screen, wherein the processing means are arranged to show markers on the screen in the displayed image of the object, wherein each recognized connected part of text and/or at least one picture is associated with at least one of the displayed markers and wherein the device is arranged such that a recognized connected part of text and/or at least one picture can be selected by means of touching the area of the screen showing the recognized connected part of text and/or at least one picture and wherein the processing means is arranged for processing in accordance with a predetermined algorithm a selected recognized connected part of text and/or at least one picture.

The present invention relates to a low vision device for recording an object whereon text and/or at least one picture are visible and for displaying the recorded object on a screen, provided with a light sensitive sensor for recording the object and providing recording signals representing the recorded object, processing means for processing the recording signals into video signals and a screen which, in use, is provided with the video signals for displaying an image of the recorded object on the screen, wherein the processing means is arranged for recognizing, based on the recording signals connected parts of text and/or at least one picture on the object. The present invention also relates to a method for recording an object whereon text and/or at least one picture are visible and for displaying the recorded object on a screen, wherein the method comprises the steps of:

recording the object by means of a light sensitive sensor;

displaying an image of the recorded object on a screen; recognizing connected parts of text and/or at least one picture on the object.

Such a low vision device and method are used by visually impaired persons.

Such a device and method are known. The object may for example be a newspaper or a magazine, comprising text and/or at least one picture. In use, the object is usually positioned on a flat surface below the light sensitive sensor. By means of the light sensitive sensor the object is recorded and an image of the recorded object is projected on the screen. By means of the processing means it is possible to enlarge the image for better viewing of certain parts of the text and/or at least one picture. It is also known that the processing means is arranged for recognizing, based on the recording signals connected parts of text and/or at least one picture on the object. A connected part of text may for example be a text block such as a column. Also it may be for example a photo or a graph. It is possible that the device is arranged by means of optical character recognition to read the text of a column and to convert this column of text into speech, which speech is outputted by means of a speaker.

It is an object of the invention to further improve the ease of use of the known device and method. It is further an object of the invention to extend the range of applications of the known device and method.

The low vision device according to the invention is characterized in that the screen is arranged as a touch screen, wherein the processing means are arranged to show markers on the screen in the displayed image of the object, wherein each recognized connected part of text and/or at least one picture is associated with at least one of the displayed markers and wherein the device is arranged such that a recognized connected part of text and/or at least one picture can be selected by means of touching the area of the screen showing a recognized connected part of text and/or at least one picture and wherein the processing means is arranged for processing in accordance with a predetermined algorithm a selected recognized connected part of text and/or at least one picture; or characterized in that the screen is arranged as a touch screen, wherein the processing means are arranged for displaying an image of the recorded object on the screen without markers and wherein the device is arranged such that a recognized connected part of text and/or at least one picture can be selected by means of touching the area of the screen showing the recognized connected part of text and/or at least one picture and wherein the processing means is arranged for processing in accordance with a predetermined algorithm a selected recognized connected part of text and/or at least one picture. Thus, in use, a person can select by means of touching the touch screen a recognized connected part of text and/or at least one picture. Thus, if the recognized connected part of text and/or at least one picture is for example a column of text in a newspaper, the person can select this column by touching the area on the screen showing the recognised connected part of text in the form of a column or the person can select this column by touching the area on the screen showing the recognised connected part of text in the form of a column associated with the marker. Then, the processing means is arranged for processing this column of text in accordance with the predetermined algorithm. The processing in accordance with the predetermined algorithm can for example involve the steps of enlarging an image of the column and displaying the enlarged column on the screen. It is also for example possible that the predetermined algorithm is carrying out a character recognition (OCR) on the column of text.

The device may be provided with a loudspeaker, wherein the recognized (by means of OCR) text of the column is outputted in speech by means of the loudspeaker. It is also possible that the processing means is arranged to carry out a character recognition on the recorded object first. Only after selecting the recognized connected part of text and/or at least one picture, the recognized text of the selected recognized part of text and/or at least one image will then be outputted in speech by means of the loudspeaker. It is also possible that the processing means is arranged to carry out a character recognition on the recorded object before the processing means, in use, adds the markers in the image on the screen. It is even possible that the processing means is arranged to carry out a character recognition on the recorded object before the processing means, in use, based on the recording signals recognizes connected parts of text and/or at least one picture on the object. This is also possible when the processing means are arranged for displaying an image of the recorded object on the screen without markers.

In more general terms, the device may be provided with a loudspeaker, wherein the predetermined algorithm, in use, can result in outputting by means of the loudspeaker at least a portion of the selected recognized connected part of text and/or at least one picture in speech, or wherein the predetermined algorithm, in use, can result in outputting by means of the loudspeaker at least a portion of the selected recognized connected part of text and/or at least one picture in speech, wherein the outputting starts from the position where the touch screen is touched for selecting a recognized connected part of text and/or at least one image and ends on a end of the selected recognized connected part of text and/or at least one picture.

Another example of a possible processing in accordance with a predetermined algorithm is the recognition of colour of the column of text. The column of text may for example be printed in black, blue or red and the recognized colour may again be outputted in speech by means of the loudspeaker. Other types of processing of a selected recognized connected part of the text and/or images in accordance with the predetermined algorithm are also possible.

Preferably it holds that, in case the processing means are arranged to show markers on the screen in the displayed image of the object, each marker is associated with one of the recognized connected parts of text and/or at least one picture. This means that there is a one to one relation between each marker and each recognized connected part of text and/or at least one picture.

It is, in accordance with the invention, also possible that the device is arranged to recognize a picture as a connected part of text and/or at least one picture. In other words, the device recognizes a picture and the picture, in case the processing means are arranged to show markers on the screen in the displayed image of the object, is associated with a marker which is displayed on the screen. Again, by activating the area showing the picture on the screen, a processing in accordance with a predetermined algorithm of the picture can be carried out. The user may for example select what type of processing has to be carried out such as enlarging the selected picture on the screen, recognizing colours of the picture, adapting the brightness and/or contrast of the picture, adapting the colour of the text and/or of the background or neighbouring portions of the image to enlarge the contrast or readability etc. Please note that it is not desired, although not excluded to change the colour of pictures. It is noted that in the context of this application a picture may be a photo, a graph, a drawing etc. In is further noted that a recognized connected part of text and/or at least one picture may comprise a recognized connected text, recognized connected pictures, a recognized single picture or a recognized connected part which comprises text and at least one picture. A recognized connected part of text and/or at least one picture is usually surrounded by a blank area which does not comprise text and/or at least one picture. This type of recognition is known as such and can for example be based on recognizing and combining blank area's on the object which do not comprise text or at least one picture. Such areas separate connected parts of text and/or at least one picture.

It is noted that in accordance with the invention, in case the processing means are arranged to show markers on the screen in the displayed image of the object, the markers are shown on the screen in the displayed image of the object. This enables a very easy way for a user to select a recognized connected part of text and/or picture. Preferably it holds that a marker which is associated with a recognized connected part of text and/or at least one picture is displayed in this connected part of text and/or at least one picture. This makes it very easy for a person to select a recognized connected part of text and/or at least one picture on the touchscreen. By moving his finger towards the recognized connected part of text and/or at least one picture he is moving his finger at the same time towards the associated marker. Thereby the risk that a wrong recognised connected part of text and/or at least one picture is selected is minimized. Preferably it holds that the marker itself has to be touched for selecting a recognised connected part of text and/or at least one picture associated with this marker.

Preferably it holds that, in case the processing means are arranged to show markers on the screen in the displayed image of the object, the marker has the form of a character displayed on the screen in the connected part of text and/or at least one picture. Preferably it holds that the recognized connected parts of text and/or at least one picture are numbered by means of the markers. Thus, in case, for example, two columns of text and three pictures are recognized, five markers are used corresponding to and showing the numbers one to five respectively.

Preferably it holds that the predetermined algorithm, in use, results in displaying a touch bar with touch buttons on the screen. The device is preferably arranged to select by means of touching a button on the screen a corresponding possibility for processing a selected recognised connected part of text and/or at least one picture from a plurality of possibilities for processing a selected recognized connected part of text and/or at least one picture. The processing according to the predetermined algorithm may for example comprise: displaying an image of the selected recognized connected part of text and/or at least one picture, wherein the enlargement, brightness and/or contrast of the selected connected part of text and/or at least one picture has changed. It may however also comprise carrying out a character recognition of the text of the selected recognized connected part of text and/or at least one picture or outputting in speech by means of a loudspeaker the recognised text of a selected connected part of text and at least one picture. As is known as such, the speech may be outputted in words and/or characters. It may also comprise carrying out a colour recognition on the selected recognized connected part of text and/or at least one picture. A user may, for example, first touch a button for selecting the type of processing which is required and subsequently select a recognized connected part of text and/or at least one picture for indicating on which recognized connected part of text and/or at least one picture the processing should be carried out. It is however also possible that a user first selects by means of the touch screen a recognized connected part of text and/or at least one picture shown on the touch screen and whereon a processing should be carried out. Subsequently, the type of processing may be selected by touching one of the buttons of the touch bar. It may also be that if no button is selected, that the default processing is enlargement.

Preferably it holds that the device is provided with a bottom plate for carrying the object, and a stand connected to the plate, wherein the sensor is mounted to the stand above the plate. Preferably the screen is also mounted to the stand above the plate. It is however also possible that the screen is positioned independent from the plate and stand, for example, adjacent to the plate and stand. The processing means of the low vision device may for example be formed by a separate computer such as a personal computer. Thus, the low vision device may be an assembly of a personal computer, a touchscreen and a plate with stand provided with the light sensitive sensor. The processing means may also be a dedicated processor.

In an embodiment of a device according to the invention the light sensitive sensor, the screen, the processing means and the loudspeaker are integrated in a single housing. In this manner it is possible to manually place the single housing on the object such that the light sensitive sensor can record the object, as a result of which the device is usable in a versatile way.

In a further embodiment of a device according to the invention, the device is arranged such that, in use, by means of touching the area of the screen showing a recognized connected part of text anchor at least one picture for at least a minimum period of the time, the default processing is enlargement of the recognized connected part of text and/or at least one picture centered around the touched area. In this manner operation of the device can be made more user friendly.

In a still further embodiment of a device according to the invention, the device is arranged such that, in use, the area of the screen showing the connected part of text and/or at least one picture which is intended to be touched can be swiped over the screen for positioning the area in a touching position, preferably the centre of the screen.

It can be advantageous when the processing means is arranged for starting recognizing, based on the recording signals connected parts of text and/or at least one picture on the object and/or processing in accordance with a predetermined algorithm a selected recognized connected part of text and/or at least one picture only after touching the screen displaying the image of the recorded object. In this manner the processing means are only activated upon user input which can prevent unnecessary computing by the processing means, which can lead to less energy consumption of the device. It is then particularly advantageous when the light sensitive sensor comprises an optical zoom camera and an OCR-camera, wherein the optical zoom camera is arranged for, in use, displaying the image of the object on the screen, preferably enlarged, and wherein the OCR-camera is arranged for, in use, providing the recording signals representing the recorded object to the processing means for recognizing, based on the recording signals connected parts of text and/or at least one picture on the object. The optical zoom camera can be a separate camera and the OCR-camera can be incorporated with the screen, the processing means and the loudspeaker in a single housing.

It is then favorable when the OCR-camera is arranged for, in use, displaying an OCR-field on the screen indicating a field with optimal resolution of the OCR-camera. It is then possible to position the object such that an area of interest of the object is visible in the OCR-field, so that processing can take place optimally.

In a still further embodiment of a device according to the invention, the device is arranged such that a recognized connected part of text and/or at least one picture can be selected by means of touching the area of the screen showing the recognized connected part of text and/or at least one picture after the displayed image if the recorded object on the screen has been enlarged. In this manner it can be prevented that unintendedly the wrong area on the screen is touched.

The invention will now be further described with reference to the drawings, wherein:

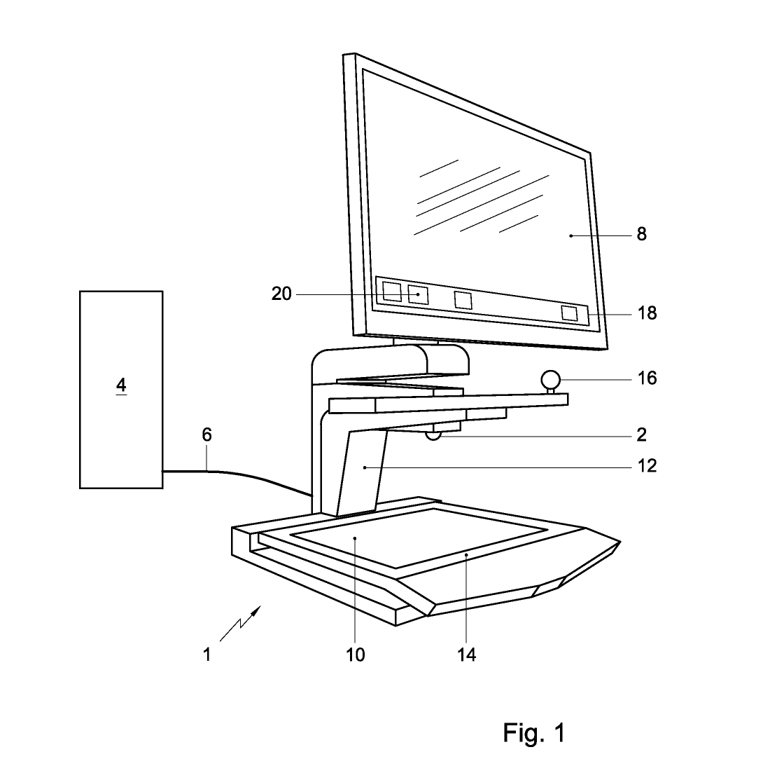

FIG. 1 shows a first embodiment of a device according to the invention for carrying out a method according to the invention;

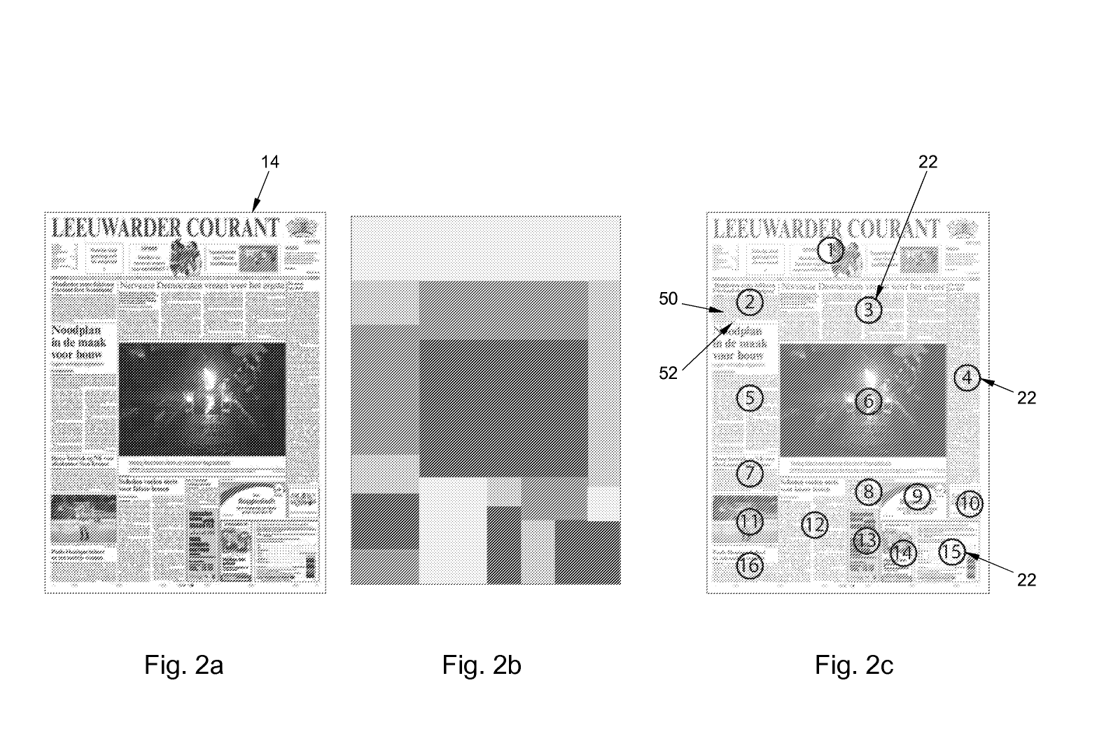

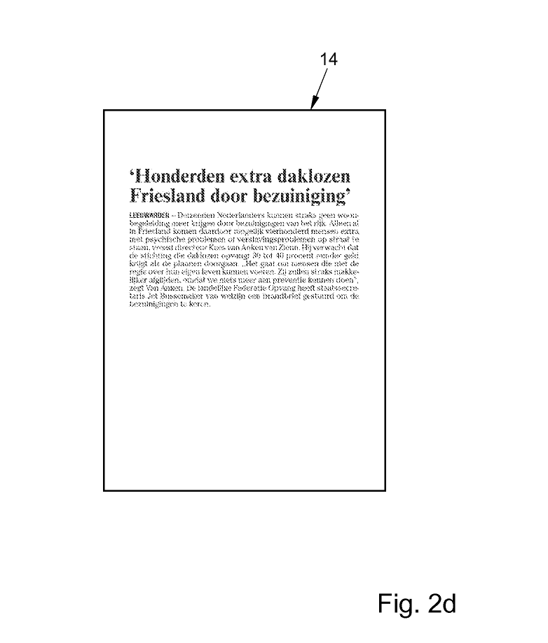

FIG. 2a shows a possible embodiment of an object which is recorded by the device;

FIG. 2b shows a possible step which is carried out by a processing means of the device;

FIG. 2c shows an image of the object as shown on the screen of the device;

FIG. 2d shows a processed image of a selected connected part of text as shown on the screen;

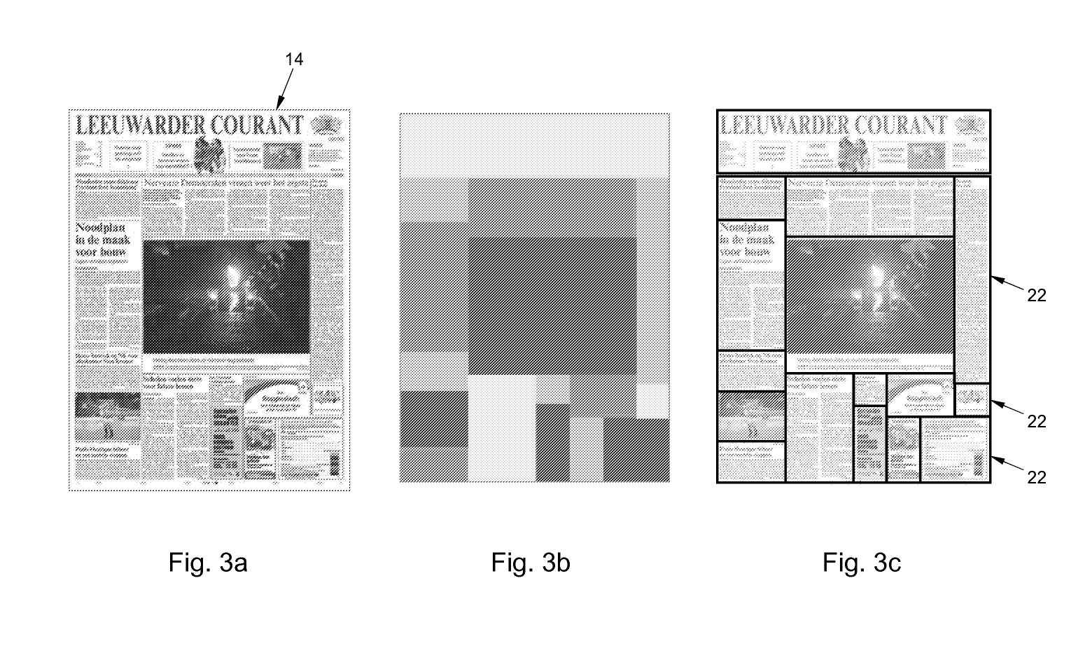

FIG. 3a shows a possible object which is recorded by the device;

FIG. 3b shows a possible processing result of the device according to the invention; and

FIG. 3c shows an alternative image of the device which is shown on the screen.

In FIG. 1 a low vision device to be used by a visually impaired person is indicated by reference number 1. The low vision device 1 is provided with a light sensitive sensor 2 for recording an object and providing recording signals representing the recorded object. The low vision device is further provided with processing means 4. In this example the processing means 4 are formed by a personal computer which is connected to the sensor 2 by means of a cable 6. The low vision device is further provided with a screen 8. The screen 8 is arranged as a touchscreen. In this example, the low vision device is further provided with a bottom plate 10 for carrying an object 14 to be displayed on the screen 8. Attached to the bottom plate 10 is an upstanding stand 12. The sensor 2 is mounted to the stand so that it is positioned above the bottom plate 10. In this example, the screen 8 is also mounted to the upstanding stand 12 so that it is located above the bottom plate 10 and above the sensor 2.

The screen 8 is also connected to the personal computer 4 by means of the cable 6. In use, an object 14 whereon text and/or at least one picture are visible, is positioned on the bottom plate 10. The object is, for example, a newspaper or a magazine. By means of the light sensitive sensor 2 recording signals are generated which represent the recorded object. The processing means 4 are arranged for processing the recording signals into video signals to be submitted to the screen 8 for displaying an image of the recorded object on the screen. The personal computer is provided with software so that the processing means which are formed by the personal computer are arranged for processing the recording signals into video signals which, in use, is submitted to the screen 8 for displaying an image of the recorded object on the screen. Furthermore, the processing means are arranged for recognizing, based on the recording signals, connected parts of text and/or images on the object.

FIG. 2a shows an example of the object 14. In this example the object is provided with columns of text and pictures. Based on non-printed areas of the newspaper the processing means can recognize connected parts of text and/or at least one picture. A connected part of text is for example a column. A connected part of at least one picture is for example a photo or a graph.

The processing means are arranged in this example to recognize areas, wherein each area comprises a connected part of text and/or at least one picture, wherein a connected part comprises text or a picture.

In FIG. 2b it is shown how the processing means in this example recognizes connected parts of text and connected parts of at least one picture. Each block in FIG. 2b corresponds to a connected part of text or a connected part which comprises a picture.

Furthermore, the processing means are arranged to show markers on the screen in the displayed image of the object as is shown in FIG. 2c. Thus FIG. 2c shows an image of the object which is shown on the screen. Each recognized connected part of text and/or at least one picture is associated with one of the displayed markers. In this example it holds that a marker which is associated with a connected part of text and/or at least one picture is displayed in this connected part of text and/or at least one picture. In this example a marker is shown in the form of a number within a circle. In the example of FIG. 2c sixteen markers are shown. This means that in this example sixteen connected parts of text and/or at least one picture been recognized by the processing means.

The device is arranged such that a connected part of text and/or at least one picture can be selected by means of touching the area of the screen showing the connected part of text and/or at least one picture. Please note that the device is arranged such that it is possible to swipe the image, such that the area of the screen showing the connected part of text and/or at least one picture which is intended to be touched can be positioned in a favourable touching position, for example the centre of the screen. Thus, a column of text associated with the marker numbered 2 can be selected by touching the area on the screen which shows this column of text. The processing means is arranged for processing in accordance with a predetermined algorithm a selected recognised connected part of text and/or images. To avoid unnecessary processing, the processing means is arranged for starting recognizing, based on the recording signals connected parts of text and/or at least one picture on the object and/or processing in accordance with a predetermined algorithm a selected recognized connected part of text and/or at least one picture only after touching the screen displaying the image of the recorded object. Although not depicted in the figures, this can be realized in an efficient and user friendly manner in an embodiment of a device according to the invention in which the light sensitive sensor comprises an optical zoom camera and an OCR-camera, wherein the optical zoom camera is arranged for displaying the image of the object on the screen, preferably enlarged, and wherein the OCR-camera is arranged for providing the recording signals representing the recorded object to the processing means for recognizing, based on the recording signals connected parts of text and/or at least one picture on the object. By touching the screen the optical zoom camera can be deactivated and the OCR-camera activated which leads to a change of image on the screen, which change indicates a user that the processing is activated. In order to make it possible that processing can take place optimally the OCR-camera is arranged for, in use, displaying an OCR-field on the screen indicating a field with optimal resolution of the OCR-camera. The object can then be positioned such that the area of interest of the object is visible in the OCR-field for providing optimal recording signals. The OCR-camera preferably has a narrow field of vision tailored for processing, while the optical zoom camera is arranged for at least providing a complete overview of the object and can e.g. have a zoom range between 2× to 24× magnification.

Thus, if the area comprising the column of text which is associated with marker numbered 2 is touched, the text of this area will be processed in accordance with the predetermined algorithm. For example, the predetermined algorithm, in use, can result in showing an enlarged image of the selected connected part of text and/or at least one picture on the screen. The predetermined algorithm can also result in outputting in speech by means of the loudspeaker the selected recognised connected part of text and/or at least one image. For example, by touching the area of the screen showing a recognized connected part of text and/or at least one picture for at least a minimum period of the time, e.g. a minimum period of about 2 seconds, the predetermined algorithm, in use, can result in a default processing which enlarges the recognized connected part of text and/or at least one picture centered around the touched area. In case the device is arranged such that a recognized connected part of text and/or at least one picture can be selected by means of touching the area of the screen showing the recognized connected part of text and/or at least one picture after the displayed image if the recorded object on the screen has been enlarged, unintendedly touching the wrong area on the screen can be prevented.

An example is shown in FIG. 2d, wherein after selecting the connected part of text associated with marker numbered 2 is touched. It is however also possible that the predetermined algorithm, in use, can result in carrying out a character recognition of the text of the selected recognized connected part of text and/or at least one picture.

In this example, the device is provided with a loudspeaker 16, wherein the predetermined algorithm, in use, can result in outputting speech which represents the recognized characters from the selected recognized connected part of text and/or at least one picture. Thus the predetermined algorithm can also result in outputting in speech by means of the loudspeaker the (complete) selected recognised connected part of text and/or at least one picture. Alternatively the predetermined algorithm, in use, can result in outputting in speech by means of the loudspeaker at least a portion of the selected recognized connected part of text and/or at least one picture, wherein the outputting in speech starts from the position (50) where the touch screen is touched for selecting a recognized connected part of text and/or at least one picture (for example the column indicated with marker 2) and the outputting in speech ends on a end (52) of the selected recognized connected part of text and/or at least one picture, alternatively the speech can carry on to the next recognized connected part of text and/or at least one picture. In a particular user friendly embodiment of the invention the device is arranged such that touching a recognized connected part of text and/or at least one picture which is not enlarged displayed on the screen results in outputting speech by means of the loudspeaker the selected recognized connected part of text and/or at least one picture from the beginning, whereas touching a recognized connected part of text and/or at least one picture which is displayed in an enlarged manner on the screen results in outputting speech by means of the loudspeaker the selected recognized connected part of text and/or at least one picture starts from the position where the touch screen is touched. It is noted that the character recognition can also be carried out by means of the processing means first on the complete recorded object. This information can than be stored in a memory of the processing means. Then only after selecting a recognized connected part of text and/or at least one picture the portion which relates to this selection is outputted in speech by means of the loudspeaker. It is also possible that the predetermined algorithm, in use, results in carrying out a colour recognition of the selected recognized connected part of text and/or at least one picture. For example, if the selected part comprises only text which is coloured in blue, the device is arranged for outputting speech by means of the loudspeaker which represents the recognized at least one colour from the selected connected part of text and/or at least one picture. If several colours are recognized, it may be that each of the colours which are recognized are outputted by means of speech. The same applies of the selected recognized text and/or at least one picture comprises a photo. In that case the colours of the photo may be outputted in speech.

As is shown in FIG. 1 the predetermined algorithm, in use, results in displaying a touch bar 18 with touch buttons 20 on the screen. The device is arranged to select by means of touching a button on the screen a possibility of processing a selected recognised connected part of text and/or at least one picture by means of the predetermined algorithm from a plurality of possibilities of processing by means of the predetermined algorithm a selected recognized connected part of text and/or at least one picture. In this example it holds that, in use, the touch bar is permanently shown on the bottom of the screen. The possibilities of processing according to the predetermined algorithm comprises for example displaying an image of the selected recognized connected part of text and/or at least one picture, wherein the enlargement, brightness and/or contrast has changed, thus by for example, first selecting a recognized connected part of text and/or at least one picture by touching the area of this recognized connected part of text and/or at least one picture and by subsequently pushing one of the buttons it can be selected how the selected recognized connected part of text and/or at least one picture is processed. This may, for example, be enlargement, brightness and/or contrast, adapting the colour of the text and/or of the background or neighbouring portions of the image to enlarge the contrast or readability. In particular effective for use by visually impaired persons the colour of the text is adapted to be yellow and the colour of the background is chosen to be black, or vice versa. After processing this selected recognized connected part of text and/or at least one picture, the result of this processing is shown on the screen 8. By selecting another button, it may be that a function for character recognition of the text of the selected recognized connected part of text and/or at least one picture is selected. As indicated above, recognized text can be outputted via the loudspeaker by means of speech. Also by pushing another button, colour recognition of the selected recognized connected part of text and/or at least one picture can be selected. The invention is however not limited to these possibilities. Also the invention is not limited in the sequence, wherein the selections are made. Thus, it possible that to select a preferred type of processing such as enlargement first by pushing the appropriate button 20 in the touch bar. Once this function is selected, it is possible to select a recognized connected part of text and/or at least one picture by touching the area of the screen which shows this recognized connected part of text and/or at least one picture, after which the selected functions such as enlargement for this selected recognized part of text and/or at least one picture is carried out.

In this example it holds that a connected part of text and/or at least one picture comprises text or a single picture. Thus, in this embodiment each connected part comprises text or a single picture. It is however also possible in other embodiments that a series of pictures which are adjacent to each other are recognized as a connected part of text and/or at least one picture. It is also possible that a text column which comprises a picture is recognized as a connected part of text anchor at least one picture.

The invention is not limited to the above described preferred embodiment. In the above referred embodiment it was possible to select a recognized connected part of text anchor at least one picture by touching the area on the screen which shows the recognized connected part of text and/or at least one picture. It is however also possible that it is required that the associated marker is touched. Thus, for example, for selecting the recognized connected part of text which is associated with marker number 3, marker number 3 must the touched on the screen.

In this example the markers are in the form of numbers. As shown in FIG. 3c it is however also possible that a marker has the form of a frame displayed on the screen, wherein the frame surrounds a recognized connected part of text and/or at least one picture. As shown in FIG. 3c each of the sixteen recognized connected parts of text and/or at least one picture is surrounded by a frame 22. In this case, each recognized connected part of text and/or at least one picture can be selected by touching the area on the screen within a frame and which shows the recognized connected part of text anchor at least one picture.

Thus FIG. 3c provides an alternative embodiment for FIG. 2c. As shown in FIG. 3a-3c, the way wherein the connected parts of text and/or at least one picture is recognized is the same as discussed in relation to FIG. 2a-2c.

In the above referred to example, each recognized connected part of text and/or at least one picture was provided with one marker. It is however also possible that for example each recognized connected part of text and/or at least one picture is provided with a first type of marker, a second type of marker and possibly further types of markers. If the first type of marker is touched, the associated recognized connected part of text and/or at least one picture is selected for, for example, showing an enlarged image on the screen of this selected connected part of text and/or at least one picture. By touching the second type of marker, the above referred to OCR function is activated for outputting the content of the selected connected part of text and/or at least one picture by means of speech should the content comprise text. In case it does not comprise text, the output may for example be “this selection does not comprise text but only pictures”. It will be clear that it is also possible that more than two types of markers are associated with a recognized connected part of text and/or at least one picture, wherein each type of marker is for activating a predetermined function (processing of the selected recognized connected part of text and/or at least one picture) of the predetermined algorithm, wherein different types of markers are associated with different types of predetermined functions of the predetermined algorithm. Such varieties each fall within the scope of the present invention.

Thus it holds that the device may be characterized in that the processing means are arranged such that, in use each recognized connected part of text and/or at least one picture is associated with a plurality of types of markers, wherein the device is arranged such that a recognized connected part of text and/or at least one picture can be selected by means of touching at least one of the markers associated with the recognized connected part of text and/or at least one picture and wherein the touching of different types of markers will result in different types of processing of the selected recognized connected part of text and/or at least one picture in accordance with the predetermined algorithm, wherein types of processing are for example: displaying an enlargement of the selected recognized connected part of text and/or at least one picture, recognizing a color the of the selected recognized connected part of text and/or at least one picture and/or performing an OCR function on the selected recognized connected part of text and/or at least one picture. Please note, although in the Figures embodiments of the invention have been described in which the processing means are arranged for displaying an image of the recorded object on the screen with markers, in other embodiments of the invention the processing means can be arranged for displaying an image of the recorded object on the screen without markers. In this latter embodiments the recognized connected parts of text and/or at least one picture can for example be electronically present in the processing means only and selection of a recognized connected part of text and/or at least one picture can activate the processing means to process the selected recognized connected part of text and/or at least one picture in accordance with the predetermined algorithm.

In addition, although in the Figures embodiments of the invention have been described in which the processing means, the light sensitive sensor, the loudspeaker and the screen are indicated as separate entities, in other embodiments of the invention the light sensitive sensor, the screen, the processing means and the loudspeaker can be integrated in a single housing. In this manner the inventive device can be arranged as a hand held device and it therefore is possible to manually place the single housing on the object such that the light sensitive sensor can record the object, as a result of which the device is usable in a versatile way.

In the above examples the processing means is formed by a personal computer provided with the required software. It is however also possible that the device is provided with a dedicated processing means especially designed for carrying out the above referred to method.

1. Low vision device for recording an object whereon text and/or at least one picture are visible and for displaying the recorded object on a screen, provided with a light sensitive sensor for recording the object and providing recording signals representing the recorded object, processing means for processing the recording signals into video signals and a screen which, in use, is provided with the video signals for displaying an image of the recorded object on the screen, wherein the processing means is arranged for recognizing, based on the recording signals connected parts of text anchor at least one picture on the object, characterized in that the screen is arranged as a touch screen, wherein the processing means are arranged to show markers on the screen in the displayed image of the object, wherein each recognized connected part of text and/or at least one picture is associated with at least one of the displayed markers and wherein the device is arranged such that a recognized connected part of text and/or at least one picture can be selected by means of touching the area of the screen showing the recognized connected part of text and/or at least one picture and wherein the processing means is arranged for processing in accordance with a predetermined algorithm a selected recognized connected part of text and/or at least one picture; or characterized in that the screen is arranged as a touch screen, wherein the processing means are arranged for displaying an image of the recorded object on the screen without markers and wherein the device is arranged such that a recognized connected part of text anchor at least one picture can be selected by means of touching the area of the screen showing the recognized connected part of text anchor at least one picture and wherein the processing means is arranged for processing in accordance with a predetermined algorithm a selected recognized connected part of text anchor at least one picture.

2. Device according to claim 1, characterized in that, in case the processing means are arranged to show markers on the screen in the displayed image of the object, the device is arranged such that a recognized connected part of text and/or at least one picture can be selected by means of touching the marker on the touch screen which is associated with the recognized connected part of text and/or at least one picture.

3. Device according to claim 1 or 2, characterized in that, in case the processing means are arranged to show markers on the screen in the displayed image of the object, each marker is associated with one of the recognized connected parts of text and/or at least one picture.

4. Device according to claim 1, 2 or 3, characterized in that the predetermined algorithm, in use, can result in showing an enlarged image of the selected recognized connected part of text and/or at least one picture on the screen.

5. Device according to any preceding claim, characterized in that, the device is provided with a loudspeaker, wherein the predetermined algorithm, in use, can result in outputting by means of the loudspeaker at least a portion of the selected recognized connected part of text and/or at least one picture in speech, or wherein the predetermined algorithm, in use, can result in outputting by means of the loudspeaker at least a portion of the selected recognized connected part of text and/or at least one picture in speech, wherein the outputting starts from the position where the touch screen is touched for selecting a recognized connected part of text and/or at least one picture and ends on an end of the selected recognized connected part of text and/or at least one picture.

6. Device according to any preceding claim, characterized in that, the predetermined algorithm, in use, can result in carrying out a character recognition (OCR) of the text of the selected recognized connected part of text and/or at least one picture or that the predetermined algorithm, in use, results in carrying out a character recognition (OCR) of the recorded object before the connected parts of text and/or at least one picture are recognized.

7. Device according to claim 6, characterized in that, the device is provided with a loudspeaker and wherein the predetermined algorithm, in use, can result in outputting speech which represents the recognized characters from the selected recognized connected parts of text and/or at least one picture by means of speech.

8. Device according to any preceding claim, characterized in that, the predetermined algorithm, in use, can result in carrying out a color recognition of the selected recognized connected part of text and/or at least one picture.

9. Device according to claim 8, characterized in that, the device is provided with a loudspeaker and wherein the predetermined algorithm, in use, results in outputting speech which represents the recognized at least one color from the selected recognized connected part of text and/or at least one picture by means of speech.

10. Device according to any preceding claim, characterized in that, in case the processing means are arranged to show markers on the screen in the displayed image of the object, a marker which is associated with a recognized connected part of text and/or images is displayed on the screen in this recognized connected part of text and/or at least one picture.

11. Device according to claims 10, characterized in that the marker has the form of a character displayed on the screen in the recognized connected part of text and/or at least one picture.

12. Device according to claim 11, characterized in that the recognized connected parts of text and/or at least one picture are numbered by means of the markers.

13. Device according to any preceding claim, characterized in that, in case the processing means are arranged to show markers on the screen in the displayed image of the object, a marker has the form of a frame displayed on the screen and surrounding a recognized connected part of text and/or at least one picture.

14. Device according to any preceding claim, characterized in that the predetermined algorithm, in use, results in displaying a touch bar with touch buttons on the screen.

15. Device according to claim 14, characterized in that, the device is arranged to select by means of touching a button on the screen a possibility of processing by means of the predetermined algorithm a selected recognized connected part of text and/or at least one picture from a plurality of possibilities of processing by means of the predetermined algorithm a selected recognized connected part of text and/or at least one picture.

16. Device according to any preceding claim 14 or 15, characterized in that, in use, the touch bar is permanently shown on preferably the bottom of the screen.

17. Device according to any preceding claim, characterized in that possibilities of processing according to the predetermined algorithm comprise: displaying an image of the selected recognized connected part of text and/or at least one picture, wherein the enlargement, brightness and/or contrast has changed, carrying out a character recognition (OCR) on the text of the selected recognized connected part of text, outputting in speech by means of a loudspeaker at least a portion of the selected recognized connected part of text and/or at least one picture, and/or at least one picture and/or carrying out a color recognition of the selected recognized connected part of text and/or at least one picture.

18. Device according to claim 17, characterized in that, wherein the processing according to the predetermined algorithm in case of changing contrast includes adapting the colour of the text and/or of the background or neighbouring portions of the image and leaving the image unchanged.

19. Device according to any preceding claim, wherein the device is provided with a bottom plate for carrying the object, an upstanding stand connected to the bottom plate, wherein the sensor is mounted to the stand above the bottom plate and wherein preferably the screen is also mounted to the stand above the plate.

20. Device according to claim 19, characterized in that the bottom plate is designed to be movable relative to the sensor of the device in two dimensions of a horizontal plane for selecting a portion of the object to be recorded by the sensor.

21. Device according to any preceding claim, characterized in that a recognized connected part of text and/or at least one picture comprises a recognized connected text, recognized connected pictures, a recognized single picture or a recognized connected part which comprises text and at least one picture.

22. Device according to any preceding claim, characterized in that, in case the processing means are arranged to show markers on the screen in the displayed image of the object, the processing means are arranged such that, in use, each recognized connected part of text and/or at least one picture is associated with a plurality of types of markers, wherein the device is arranged such that a recognized connected part of text and/or at least one picture can be selected by means of touching at least one of the markers associated with the recognized connected part of text and/or at least one picture and wherein the touching of different types of markers will result in different types of processing of the selected recognized connected part of text and/or at least one picture in accordance with the predetermined algorithm, wherein types of processing are for example: displaying an enlargement of the selected recognized connected part of text and/or at least one picture, recognizing a color the of the selected recognized connected part of text and/or at least one picture and/or performing an OCR function on the selected recognized connected part of text and/or at least one picture.

23. Device according to at least one of the claim 5, 7, 9 or 17, characterized in that the light sensitive sensor, the screen, the processing means and the loudspeaker are integrated in a single housing.

24. Device according to any one of the preceding claims, characterized in that, the device is arranged such that, in use, by means of touching the area of the screen showing a recognized connected part of text and/or at least one picture for at least a minimum period of the time, the default processing is enlargement of the recognized connected part of text and/or at least one picture centered around the touched area.

25. Device according to any one of the preceding claims, characterized in that, the device is arranged such that, in use, the area of the screen showing the connected part of text and/or at least one picture which is intended to be touched can be swiped over the screen for positioning the area in a touching position, preferably the centre of the screen.

26. Device according to any one of the preceding claims, characterized in that, the processing means is arranged for starting recognizing, based on the recording signals connected parts of text and/or at least one picture on the object and/or processing in accordance with a predetermined algorithm a selected recognized connected part of text and/or at least one picture only after touching the screen displaying the image of the recorded object.

27. Device according to claim 26, characterized in that, the light sensitive sensor comprises an optical zoom camera and an OCR-camera, wherein the optical zoom camera is arranged for, in use, displaying the image of the object on the screen, preferably enlarged, and wherein the OCR-camera is arranged for, in use, providing the recording signals representing the recorded object to the processing means for recognizing, based on the recording signals connected parts of text and/or at least one picture on the object.

28. Device according to claim 27, characterized in that, the OCR-camera is arranged for, in use, displaying an OCR-field on the screen indicating a field with optimal resolution of the OCR-camera.

29. Device according to any one of the preceding clams, wherein the device is arranged such that a recognized connected part of text and/or at least one picture can be selected by means of touching the area of the screen showing the recognized connected part of text and/or at least one picture after the displayed image if the recorded object on the screen has been enlarged.

30. Device according to at least claims 5, 7, 9 and 17, wherein the device is arranged such that touching a recognized connected part of text and/or at least one picture which is not enlarged displayed on the screen results in outputting speech by means of the loudspeaker the selected recognized connected part of text and/or at least one picture from the beginning, whereas touching a recognized connected part of text and/or at least one picture which is displayed in an enlarged manner on the screen results in outputting speech by means of the loudspeaker the selected recognized connected part of text and/or at least one picture starts from the position where the touch screen is touched.

31. Method for recording an object whereon text and/or at least one picture are visible and for displaying the recorded object on a screen, wherein the method comprises the steps of:
recording the object by means of a light sensitive sensor;
displaying an image of the recorded object on a screen;
recognizing connected parts of text and/or at least one picture on the object, characterized in that the screen is arranged as a touch screen, wherein the method further comprises the steps of:
associating each recognized connected part of text and/or at least one picture with at least one marker;
showing the markers on the screen in the displayed image of the object;
selecting a recognized connected part of text and/or at least one picture by means of touching the area of the screen showing the recognized connected part of text and/or at least one picture; and
processing in accordance with a predetermined algorithm a selected recognized connected part of text and/or at least one picture; or
characterized in that the screen is arranged as a touch screen, wherein the method further comprises the steps of:
showing the displayed image of the object on the screen without markers;
selecting a recognized connected part of text and/or at least one picture by means of touching the area of the screen showing the recognized connected part of text and/or at least one picture; and
processing in accordance with a predetermined algorithm a selected recognized connected part of text and/or at least one picture.

32. Method according to claim 31, characterized in that, in case each recognized connected part of text and/or at least one picture is associated with at least one marker, the method comprises the step of selecting a recognized connected part of text and/or at least one picture by touching the associated marker on the touch screen.

33. Method according to claim 31 or 32, characterized in that, in case each recognized connected part of text and/or at least one picture is associated with at least one marker, each marker is associated with one of the recognized connected part of text and/or at least one picture.

34. Method according to any preceding claim 31-33, characterized in that the predetermined algorithm results in an enlarged image of the selected recognized connected part of text anchor at least one picture being displayed on the screen.

35. Method according to any preceding claim 31-34, characterized in that, the that the predetermined algorithm results in a step wherein at least a portion of the selected recognized connected part of text and/or at least one picture is outputted in speech by means of a loudspeaker and/or a step wherein at least a portion of the selected recognized connected part of text and/or at least one picture is outputted in speech by means of a loudspeaker, wherein the outputting starts from the position where the touch screen is touched for selecting a recognized connected part of text and/or at least one image and ends on an end of the selected recognized connected part of text and/or at least one picture.

36. Method according to any preceding claims 31-35, characterized in that, that the predetermined algorithm results in a step wherein, in use, a character recognition (OCR) of the text of the selected recognized connected part of text and/or at least one picture is carried out or characterized in that the method comprises a step wherein a character recognition (OCR) of the recorded object is carried out before the connected parts of text and/or at least one picture are recognized.

37. Method according to claim 36, characterized in that, the use is made of a loudspeaker for outputting speech which represents the recognized characters from the selected recognized connected part of text and/or at least one picture.

38. Method according to any preceding claim 31-37, characterized in that, the method comprises a step wherein color recognition of the selected recognized connected part of text and/or at least one picture is carried out.

39. Method according to claim 37, characterized in that, use is made of a loudspeaker for outputting speech which represents the recognized at least one color from the selected recognized connected part of text and/or at least one picture.

40. Method according to any preceding claim 31-39, characterized in that, in case each recognized connected part of text and/or at least one picture is associated with at least one marker, a marker which is associated with a recognized connected part of text and/or images is displayed in this recognized connected part of text and/or at least one picture.

41. Method according to claims 40, characterized in that the marker has the form of a character displayed on the screen in the recognized connected part of text and/or at least one picture.

42. Method according to claim 41, characterized in that the recognized connected parts of text and/or at least one picture are numbered by means of the markers.

43. Method according to any preceding claim 31-42, characterized in that, in case each recognized connected part of text and/or at least one picture is associated with at least one marker, a marker is used which has the form of a frame displayed on the screen and which surrounds a recognized connected part of text and/or at least one picture.

44. Method according to any preceding claim 31-43, characterized in that a touch bar with touch buttons is displayed on the screen.

45. Method according to claim 44, characterized in that, the method comprises the step of selecting by means of touching a button on the screen a possibility of processing a selected recognized connected part of text and/or at least one picture by means of the predetermined algorithm from a plurality of possibilities of processing by means of the predetermined algorithm a selected recognized connected part of text and/or at least one picture.

46. Method according to any preceding claim 44 or 45, characterized in that the touch bar is permanently shown on preferably the bottom of the screen.

47. Method according to claim any preceding claim 31-46, characterized in that possibilities of processing by means of the predetermined algorithm comprise: displaying an image of the selected recognized connected part of text and/or at least one picture, wherein the enlargement, brightness and/or contrast has changed, outputting in speech by means of a loudspeaker at least a portion of the selected recognized connected part of text and/or at least one picture, carrying out a character recognition (OCR) of the text of the recognized connected part of text and/or at least one picture and/or carrying out a color recognition on the recognized connected part of text and/or at least one picture.

48. Method according to claim 47, characterized in that, the step of changing contrast includes adapting the colour of the text and/or of the background or neighbouring portions of the image and leaving the image unchanged.

49. Method according to any preceding claim 31-48, wherein use is made of a bottom plate for carrying the object, an upstanding stand connected to the bottom plate, wherein the screen and the sensor are mounted to the stand above the bottom plate.

50. Method according to claim 49, characterized in that the bottom plate moved relative to the sensor in two dimensions of a horizontal plane for selecting a portion of the object to be recorded by the sensor.

51. Method according to any preceding claim 31-50, characterized in that a recognized connected part of text and/or at least one picture comprises a recognized connected text, recognized connected pictures, a recognized single picture or a recognized connected part which comprises text and at least one picture.

52. Method according to any preceding claim 31-51, characterized in that, in case each recognized connected part of text and/or at least one picture is associated with at least one marker, each recognized connected part of text and/or at least one picture is associated with a plurality of types of markers, wherein a recognized connected part of text and/or at least one picture is selected by means'of touching at least one of the markers associated with the recognized connected part of text and/or at least one picture and upon touching different types markers different types of processing of the selected recognized connected part of text and/or at least one picture is carries out in accordance with the predetermined algorithm, wherein types of processing are for example: displaying an enlargement of the selected recognized connected part of text and/or at least one picture, recognizing a color the of the selected recognized connected part of text and/or at least one picture and/or performing an OCR function on the selected recognized connected part of text and/or at least one picture.

53. Method according to at least one of the claim 35, 37 or 47, characterized in that the light sensitive sensor, the screen and the loudspeaker are integrated in a single housing.

54. Method according to claim 53, characterized in that the method comprises the step of placing the single housing on the object such that the light sensitive sensor can record the object.

55. Method according to any one of the claims 31-54, characterized in that, the method comprises the steps of:
touching an area of the screen showing a recognized connected part of text and/or at least one picture for at least a minimum period of the time; and
default enlarging the recognized connected part of text and/or at least one picture centered around the touched area.

56. Method according to any one of the claims 31-55, characterized in that, the method comprises the step of swiping the area of the screen showing the connected part of text and/or at least one picture which is intended to be touched over the screen for positioning the area in a touching position, preferably the centre of the screen.

57. Method according to any one of the claims 31-56, characterized in that, the method performs the steps of recognizing, based on the recording signals connected parts of text and/or at least one picture on the object and/or processing in accordance with a predetermined algorithm a selected recognized connected part of text and/or at least one picture only after the screen displaying the image of the recorded object has been touched.

58. Method according to claim 57, characterized in that, the light sensitive sensor used comprises an optical zoom camera and an OCR-camera, wherein the image of the object is displayed, preferably enlarged, on the screen by means of the optical zoom camera and wherein recognizing connected parts of text and/or at least one picture on the object is based on recording signals obtained by the OCR-camera.

59. Method according to claim 58, characterized in that, the method comprises the step of displaying by means of the OCR-camera an OCR-field on the screen indicating a field with optimal resolution of the OCR-camera, and the optional step of positioning the object such that an area of interest of the object is visible in the OCR-field.

60. Method according to any one of the claims 31-59, characterized in that, the step of selecting a recognized connected part of text and/or at least one picture by means of touching the area of the screen showing the recognized connected part of text and/or at least one picture is performed after the displayed image if the recorded object on the screen has been enlarged.

61. Method according to at least claims 35, 37, 47 and 53, wherein the method comprises the step outputting speech from the beginning of the selected recognized connected part of text and/or at least one picture by touching a recognized connected part of text and/or at least one picture which is not enlarged displayed on the screen, whereas touching a recognized connected part of text and/or at least one picture which is displayed in an enlarged manner on the screen results in outputting speech by means of the loudspeaker the selected recognized connected part of text and/or at least one picture starts from the position where the touch screen is touched.
